(19) United States
(12) Patent Application Publication
(10) Pub. No.: US 2025/0264884 A1
(43) Pub. Date: Aug. 21, 2025

(54) METHOD AND APPARATUS FOR MANAGING ROBOT BATTERY BASED ON OPERATION DATA

(71) Applicants: HYUNDAI MOTOR COMPANY, Seoul (KR); Kia Corporation, Seoul (KR); SUNGSHIN WOMEN`S UNIVERSITY R&DB FOUNDATION, Seoul (KR)

(72) Inventors: Jimin HAN, Hwaseong-si (KR); Joon Young KIM, Seoul (KR); Seong Wook HWANG, Seoul (KR); Jeong Min OH, Seoul (KR); Sihyeon PARK, Chungju-si (KR); Hyo Jin SONG, Incheon (KR); Namgyo KIM, Chuncheon-si (KR); Yujin SONG, Dongducheon-si (KR)

(21) Appl. No.: 18/894,453

(22) Filed: Sep. 24, 2024

(30) Foreign Application Priority Data
Feb. 20, 2024 (KR) 10-2024-0024087

(51) Int. Cl. G05D 1/644; B25J 9/16

(52) U.S. Cl. CPC G05D 1/644; B25J 9/1661

(57) ABSTRACT

An apparatus for managing a robot battery based on operation data may include a robot data collecting unit configured to periodically collect data related to an operation of a robot, a charged state monitoring unit configured to periodically monitor a charged state of the battery of the robot based on the collected data, a charging management unit configured to issue a battery charge command to the robot based on the data and the charged state, and a task distribution command unit configured to issue a distribution command with respect to a remaining task to the robot based on the data and the charged state.

### CROSS-REFERENCE TO RELATED APPLICATION

This application claims priority to and the benefit of Korean Patent Application No. 10-2024-0024087, filed in the Korean Intellectual Property Office on Feb. 20, 2024, the entire content of which is incorporated herein by reference.

### TECHNICAL FIELD

The present disclosure relates to a method and an apparatus for managing a robot battery based on operation data. More particularly, the present disclosure relates to a method and an apparatus for managing a robot battery based on operation data and capable of efficiently managing a robot battery in a building.

### BACKGROUND

The robot control system of a robot-friendly building is designed to coordinate and efficiently utilize robots within the building. These systems integrate robot technology into various aspects of building operation and maintenance, including security and convenience management, to enhance operational efficiency and improve user experience in both living and working spaces. By integrating multiple robot functions and technologies, the system enables seamless collaboration and operation of robots within the building.

One key function of the robot control system is managing the robots' batteries. Conventional robot control systems continuously monitor the battery levels of individual robots and issue immediate charging commands when the state of charge drops below a certain threshold, regardless of the robot's remaining tasks or the overall distribution of remaining work.

### SUMMARY

The present disclosure is directed to a method and an apparatus for managing a robot battery based on operation data and capable of managing the work time and the charge time of the robot considering a real-time battery state of charge, work peak time, remaining work amount, or the like of a robot through a robot control system, when a plurality of robots are operated working while moving between various spaces.

According to one aspect of the present disclosure, an apparatus for managing a robot battery based on operation data can include a robot data collecting unit configured to periodically collect data related to an operation of a robot, a charged state monitoring unit configured to periodically monitor a charged state of the battery of the robot based on the collected data, a charging management unit configured to issue a battery charge command to the robot based on the data and the charged state, and a task distribution command unit configured to issue a distribution command with respect to a remaining task to the robot based on the data and the charged state.

The robot data collecting unit can be configured to, among data related to the operation, collect first data related to the battery of the robot from a robot battery operation database, and collect second data related to the task of the robot from robot operating unit.

The first data can include a battery amount consumed when the robot moves, a battery amount consumed for the task and a battery amount necessary for the task, and the second data may include a task amount assigned to the robot, an expected task time and a task peak time.

The robot data collecting unit can be configured to collect data including a distance from the position of the robot at the time of completing the task to a charging station and a battery amount required for moving to the charging station.

The charged state monitoring unit can be configured to, based on the first data and the second data, determine the charged state as a first charged state when it is determined that the charged state is not sufficient for performing the currently assigned task and immediate charging is necessary, determine the charged state as a second charged state when it is determined that the charged state is sufficient for completing the currently assigned task but not sufficient until task peak time is completed, and determine the charged state as a third charged state when it is determined that the charged state is sufficient until the task peak time is completed.

The charged state monitoring unit can be configured to determine the charged state as the third charged state when a value obtained by subtracting a first battery amount required for the remaining task assigned to the robot and a second battery amount required for an additional task expected until the task peak time from a current battery state of charge is greater than a third battery amount required for the robot to move to the charging station farthest from the position at the time of completing the task by a predetermined level.

The charging management unit can be configured to forcibly terminate the operation of robot when charged state of the robot is the first charged state and issue a first charging command for immediately charging the robot, issue a second charging command, for charging the robot after completing the currently assigned task, when the charged state of the robot is determined as the second charged state, and issue a third charge command for terminating the operation of the robot and charging the robot after the task peak time is finished when the charged state of the robot is determined as the third charged state.

The task distribution command unit can be configured to detect at least one robot having the third charged state, and issue the distribution command for distributing the remaining task that is not processed among tasks assigned to other robots that currently need to be charged, to a first robot having a highest state of charge among the detected at least one robot.

The task distribution command unit can be configured to call a second robot having a greatest state of charge among robots that are currently being charged and satisfying a preset state of charge, and issue the distribution command for distributing the remaining task to the called second robot, when the at least one robot having the third charged state is not detected.

The charging management unit can be configured to issue the charge command for moving to and charging at a charging station capable of charging at shortest distance regardless of the charged state when operation-terminated state is announced with respect to the robot having completed the task.

According to another aspect of the present disclosure, a method for managing a robot battery based on operation data can include periodically collecting data related to an operation of robot, periodically monitoring a charged state of the battery of the robot based on the collected data, Issuing a battery charge command to the robot based on the data and the charged state, and issuing a distribution command with respect to a remaining task to the robot based on the data and the charged state.

The collecting the data can include, among data related to the operation, collecting first data related to the battery of the robot from a robot battery operation database, and collecting second data related to the task of the robot from robot operating unit.

The first data can include a battery amount consumed when the robot moves, a battery amount consumed for the task and a battery amount necessary for the task, and the second data may include a task amount assigned to the robot, an expected task time and a task peak time.

The collecting the data can further include collecting data including a distance from the position of the robot at the time of completing the task to a charging station and a battery amount required for moving to the charging station.

The monitoring the charged state can include, based on the first data and the second data, determining the charged state as a first charged state when it is determined that the charged state is not sufficient for performing the currently assigned task and immediate charging is necessary, determining the charged state as a second charged state when it is determined that the charged state is sufficient for completing the currently assigned task but not sufficient until task peak time is completed, and determining e the charged state as a third charged state when it is determined that the charged state is sufficient until the task peak time is completed.

The monitoring the charged state can further include determining the charged state as the third charged state when a value obtained by subtracting a first battery amount required for the remaining task assigned to the robot and a second battery amount required for an additional task expected until the task peak time from a current battery state of charge is greater than a third battery amount required for the robot to move to the charging station farthest from the position at the time of completing the task by a predetermined level.

The issuing the battery charge command to the robot can include forcibly terminating the operation of the robot and issuing a first charging command for immediately charging the robot when charged state of the robot is the first charged state, issue a second charging command for charging the robot after completing the currently assigned task when the charged state of the robot is determined as the second charged state, issue a third charge command for terminating the operation of the robot and charging the robot after the task peak time is finished when the charged state of the robot is determined as the third charged state.

The issuing the distribution command with respect to the remaining task can include detecting at least one robot having the third charged state, and issuing the distribution command for distributing the remaining task that is not processed among tasks assigned to other robots that currently need to be charged to a first robot having a highest state of charge among the detected at least one robot.

The issuing the distribution command with respect to the remaining task can further include, when the at least one robot having the third charged state is not detected, calling a second robot having a greatest state of charge among robots that are currently being charged and satisfying a preset state of charge and issuing the distribution command for distributing the remaining task to the called second robot.

The issuing the battery charge command to the robot can include issuing the charge command for moving to and charging at a charging station capable of charging at shortest distance regardless of the charged state when operation-terminated state is announced with respect to robot having completed the task.

A method and an apparatus for managing a robot battery based on operation data can distribute task such that some robots may be charged in advance at the time when usage is relatively low, in order to deploy maximum number of robots during times when usage increases, such that robot operation efficiency can be maximized by scheduling the charge schedule.

A method and an apparatus for managing a robot battery based on operation data can estimate the appropriate number of robots to be operated appropriate for the location, in the long term.

### BRIEF DESCRIPTION OF THE DRAWINGS

FIG. 1 is a diagram illustrating an example of a system for managing a robot battery based on operation data.

FIG. 2 is a block diagram illustrating an example of an apparatus for managing a robot battery based on operation data.

FIG. 3 is a flowchart illustrating an example of a method for managing a robot battery based on operation data.

FIG. 4 is a drawing illustrating an example of a method for managing a robot battery based on operation data.

FIG. 5 is a flowchart illustrating an example of a method for managing a robot battery based on operation data.

FIG. 6 is a diagram illustrating an example of a method for managing a robot battery based on operation data.

FIG. 7 is a diagram illustrating an example of a computing device.

### DETAILED DESCRIPTION

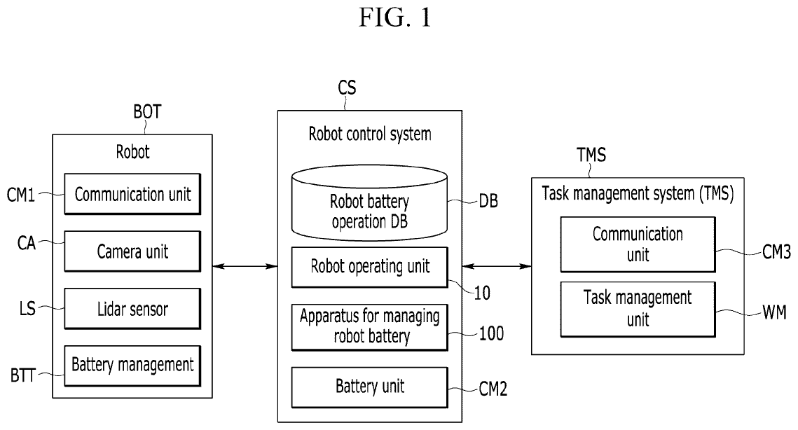

FIG. 1 schematically shows a system for managing a robot battery based on operation data.

Referring to FIG. 1, a system for managing a robot battery based on operation data may include a robot BOT, a robot control system CS, and a task management system TMS.

The robot BOT may include a plurality of robots that perform the same or similar functions. For example, the robot BOT may include a delivery robot, a serving robot, a secretary robot, or the like.

The robot BOT may correspond to the plurality of robots operated through the robot control system CS, in an environment of moving and operating in one or several spaces including robot-friendly buildings.

The robot BOT may include a communication unit CM1, a camera unit CA, a lidar sensor LS and a battery unit BTT.

The communication unit CM1 is responsible for the communication function of the robot. The communication unit CM1 may be used for the robot to communicate with the outside and to be controlled. The communication unit CM1 may exchange data with an external system or controller and receive commands, through wireless communication technology.

The communication unit CM1 may be responsible for communicating with the robot control system CS and the task management system TMS of the robot BOT.

The camera unit CA may be responsible for visual detection and processing of the robot. The camera unit CA may be used for the robot to recognize surrounding environment and collect visual information. The camera unit CA may be used to perform tasks such as obstacle detection, object recognition, mapping, or the like.

The lidar sensor LS may be used to detect and map the surrounding environment of the robot in 3D. The lidar sensor LS may precisely measure distance information of the surrounding environment by using laser. The robot may detour the obstacle or perform environment mapping by utilizing the information measured through the lidar sensor LS.

The battery unit BTT may supply power to the robot and manage the battery state. The battery unit BTT may provide the electrical energy required for operation of the robot. In addition, the battery unit BTT may monitor the battery state, and when needed, may manage energy consumption of the robot when receiving a charge command signal.

The robot control system CS may be a system for monitoring and effectively controlling the robots. The robot control system CS may track tasks and states performed by one or more robots, and may provide various functions in order to optimize efficiency, safety, and functionality of the robot.

The robot control system CS may include a robot battery operation database DB, a robot operating unit 10, a communication unit CM2 and an apparatus 100 for managing robot battery.

The robot battery operation database DB may store and manage data related to usage and operation of the robot battery. The robot battery operation database DB may record information such as the battery state, charge history, operation history, or the like of each robot, to track and evaluate performance and energy efficiency of the robot.

The robot battery operation database DB may store the battery data consumed when the robot operates the service or moves, and the charge data in a database. The robot battery operation database DB may include information pieces on estimation of battery required for performing the task, battery consumption estimation according to the moving distance, or the like.

The robot operating unit 10 is responsible for the overall operation and control of the robot. The robot operating unit 10 may control a basic operation of the robot such as motion, task perform, sensor data collection, or the like of the robot. The robot operating unit 10 may be programmed so that the robot performs a specific task, and may monitor and manipulate the state of the robot.

The robot operation unit 10 may assign and manage tasks to the robot. That is, the robot operating unit 10 may serve to assign tasks received from the task management system TMS to respective robots.

The communication unit CM2 may be responsible for communication between the robot and the external system or users. The communication unit CM2 may be responsible for communicating with the robot BOT of the robot control system CS and the task management system TMS. That is, the communication unit CM2 may enable data exchange between the robot control system CS and the robot BOT, and with respect to the external control system, and through this, may remotely monitor or control the robot.

An apparatus 100 for managing the robot battery based on operation data may be referred to as the apparatus 100 for managing the robot battery. The apparatus 100 for managing the robot battery may effectively manage the battery of the robot and may maintain its optimal performance. The apparatus 100 for managing the robot battery may manage the charged state of the battery of the robot based on the operation data of the robot.

The apparatus 100 for managing the robot battery may perform functions such as battery charge, discharge, state monitoring, issue of the charge command signal, or the like. The apparatus 100 for managing the robot battery may manage the battery of the robot such that the robot may use energy at maximally efficiently and manage the battery life-span.

That is, the apparatus 100 for managing the robot battery may manage the task time and charge time of the robot by considering real-time battery state of charge, task peak time, remaining task amount, or the like of the robot.

The task management system (TMS) may refer to software tools or systems designed to effectively manage the planning, tracking, allocation, and setting priorities of tasks or work. The task management system TMS may be used in various organizations to improve work processes and increase productivity.

The task management system TMS may be a system for managing the task request by a customer such as an order request, an order modification, an order cancellation, or the like. The task management system TMS may predict a task peak time and a task amount.

The task management system TMS may determine a peak time based on the number of the collected orders. For example, the task management system TMS may divide store operation time into specific time units (e.g., 30 minutes) to count the number of tasks for each time band, and may select a time band having a highest order volume as the peak time by taking a sum and average of order volumes of working days of the corresponding month.

The task management system TMS may include a communication unit CM3 and a task management unit WM.

The communication unit CM3 may be responsible for efficient communication with other systems, devices or users within the task management system TMS. The communication unit CM3 may support various communication protocols and communication interfaces such that the task management system TMS may exchange data and commands with other systems. For example, the communication unit CM3 may be responsible for communication between the robot BOT of the robot control system CS of the task management system TMS.

The task management unit WM may plan and manage actual tasks and works in the task management system TMS. The task management unit WM may track and monitor task schedule, assigned task, priority, process status, or the like.

In addition, the task management unit WM may assign tasks to the robot and optimize work processes. The task management unit WM may provide various task management functions such as planning and executing of the tasks, process status management, collaboration of the robots, or the like.

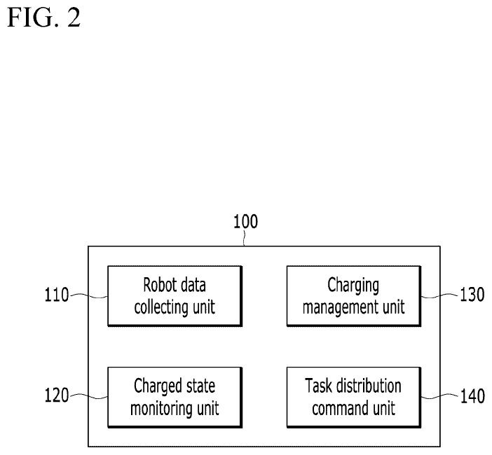

FIG. 2 is a block diagram of an apparatus for managing the robot battery based on operation data.

Referring to FIG. 2, the apparatus 100 for managing the robot battery may include the robot data collecting unit 110, a charged state monitoring unit 120, a charging management unit 130 and a task distribution command unit 140.

The robot data collecting unit 110 may periodically collect data related to an operation of the robot.

The robot data collecting unit 110 may from among the data related to the operation, collect first data related to the battery of the robot from the robot battery operation database.

The robot data collecting unit 110 may collect the second data related to the task of the robot from the robot operating unit.

The first data may include a battery amount consumed when the robot moves, a battery amount consumed for the task, and a battery amount necessary for the task. The second data may include a task amount assigned to the robot, an expected task time and a task peak time.

The robot data collecting unit 110 may collect data including a distance from the position of the robot at the time of completing the task to a charging station and a battery amount required for moving to the charging station.

The charged state monitoring unit 120 may periodically monitor the charged state of the battery of the robot based on the collected data.

The charged state monitoring unit 120 may determine the charged state based on the first data and the second data.

When it is determined that the charged state is not sufficient for performing the currently assigned task and immediate charging is necessary, the charged state monitoring unit 120 may determine the charged state as a first charged state.

When it is determined that the charged state is sufficient for completing the currently assigned task but not sufficient until the task peak time is completed, the charged state monitoring unit 120 may determine the charged state as a second charged state.

When it is determined that the charged state is sufficient until the task peak time is completed, the charged state monitoring unit 120 may determine the charged state as a third charged state.

The charged state monitoring unit 120 may determine the charged state as the third charged state when a value obtained by subtracting a first battery amount required for a remaining task assigned to the robot and a second battery amount required for an additional task expected until the task peak time from a current battery state of charge is greater than a third battery amount required for the robot to move to the charging station farthest from the position at the time of completing the task by a predetermined level.

The charging management unit 130 may issue a battery charge command signal to the robot based on the data related to the operation and the charged state.

When the charged state of the robot is the first charged state, the charging management unit 130 may issue a first charging command for forcibly terminating the operation of the robot and immediately charging the robot.

When the charged state of the robot is determined as the second charged state, the charging management unit 130 may issue a second charging command signal for charging the robot after completing the currently assigned task.

When the charged state of the robot is determined as the third charged state, the charging management unit 130 may issue a third charge command signal on the robot to charge the robot after completing the operation of the robot after the end of the task peak time.

When an operation-terminated state is announced with respect to the robot having completed the task, the charging management unit 130 may issue a charge command signal for moving to and charging at a charging station capable of charging at shortest distance regardless of the charged state to the robot.

The task distribution command unit 140 may issue a distribution command signal with respect to the remaining task to the robot based on the data and the charged state.

The task distribution command unit 140 may detect at least one robot having the third charged state, and may issue a distribution command signal for distributing the remaining task among the assigned tasks to other robots that currently need to be charged, to a first robot having a highest state of charge among the detected at least one robot.

When the at least one robot having the third charged state is not detected, the task distribution command unit 140 may call a second robot having a greatest state of charge among the robots that are currently being charged and satisfying a preset state of charge, and may issue the distribution command signal for distributing the remaining task to the called second robot.

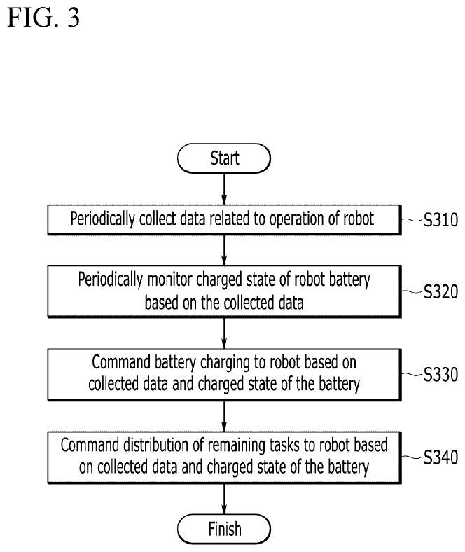

FIG. 3 is a flowchart of a method for managing a robot battery based on operation data. A method for managing a robot battery based on operation data of FIG. 3 may be performed through the apparatus 100 for managing the robot battery based on operation data (see FIG. 2).

In FIG. 3, at step S310, the apparatus 100 for managing the robot battery based on operation data may periodically collect the data related to the operation of the robot.

The apparatus 100 for managing the robot battery based on operation data may from among the data related to the operation, collect the first data related to the battery of the robot from the robot battery operation database DB (see FIG. 1).

The first data may include the battery amount consumed when the robot moves, the battery amount consumed for the task and the battery amount necessary for the task.

The apparatus 100 for managing the robot battery based on operation data may from among the data related to the operation, collect the second data related to the task of the robot from the robot operating unit 10 (see FIG. 1).

The second data may include the task amount assigned to the robot, the expected task time and the task peak time.

The apparatus 100 for managing the robot battery based on operation data may collect data with respect to the distance from the position of the robot at the time of completing the task to the charging station and the battery amount required for moving to the charging station.

At step S320, the apparatus 100 for managing the robot battery based on operation data may periodically monitor the charged state of the battery of the robot based on the collected data.

The apparatus 100 for managing the robot battery based on operation data may monitor the charged state of the battery of the robot based on the first data and the second data.

The apparatus 100 for managing the robot battery based on operation data may determine the charged state as the first charged state when it is determined that the current charged state is not sufficient for performing the currently assigned task and immediate charging is necessary.

When it is determined that the currently charged state is sufficient for completing the currently assigned task but not sufficient until the task peak time is completed, the apparatus 100 for managing the robot battery based on operation data may determine the charged state as the second charged state.

The apparatus 100 for managing the robot battery based on operation data may determine the charged state as the third charged state when it is determined that the current charged state is sufficient until the task peak time is completed.

The apparatus 100 for managing the robot battery based on operation data may determine the charged state as the third charged state when a value obtained by subtracting the first battery amount required for the remaining task assigned to the robot and the second battery amount required for an additional task expected until the task peak time from the current battery state of charge is greater than the third battery amount required for the robot to move to the charging station farthest from the position at the time of completing the task by a predetermined level.

At step S330, the apparatus 100 for managing the robot battery based on operation data may issue a battery charge command to the robot based on the collected data and the charged state of the battery.

When the charged state of the robot is the first charged state, the apparatus 100 for managing the robot battery based on operation data may issue a first charging command for forcibly terminating the operation of the robot and immediately charging the robot.

When the charged state of the robot is determined as the second charged state, the apparatus 100 for managing the robot battery based on operation data may issue a second charging command for charging the robot after completing the currently assigned task.

When the charged state of the robot is determined as the third charged state, the apparatus 100 for managing the robot battery based on operation data may issue the third charge command for charging the robot after completing the operation of the robot after the end of task peak time.

When the operation-terminated state is announced with respect to the robot having completed the task, the apparatus 100 for managing the robot battery based on operation data may issue the charge command for moving to and charging at a charging station capable of charging at shortest distance regardless of the charged state.

At step S340, the apparatus 100 for managing the robot battery based on operation data may issue the distribution command with respect to the remaining task to the robot based on the collected data and the charged state of the battery.

The apparatus 100 for managing the robot battery based on operation data may detect the at least one robot having the third charged state, and may issue the distribution command for distributing the remaining task that is not processed among tasks assigned to other robots that currently need to be charged to the first robot having a highest state of charge among the detected at least one robot.

When the at least one robot having the third charged state is not detected, the apparatus 100 for managing the robot battery based on operation data may call the second robot having a greatest state of charge among the robots that are currently being charged and satisfying a preset state of charge, and may issue the distribution command for distributing the remaining task to the called second robot.

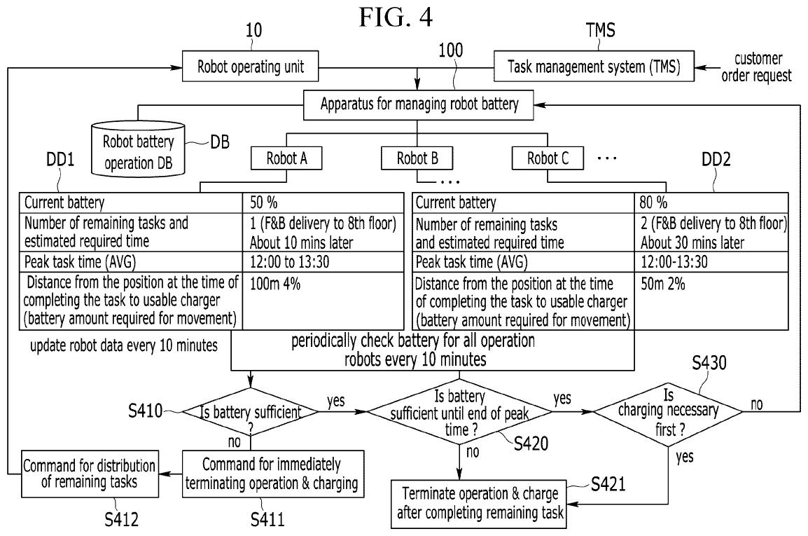

FIG. 4 is a drawing for explaining a method for managing a robot battery based on operation data. FIG. 4 is a drawing showing an example of a method for managing a robot battery based on operation data FIG. 3.

In FIG. 4, the apparatus 100 for managing the robot battery may manage batteries of the plurality of robots including the robot A, the robot B and the robot C. The apparatus 100 for managing the robot battery may manage the battery state of charge of the plurality of robots based on operation data with respect to the plurality of robots.

In some implementations, when a customer's order is received through the task management system TMS, the robot control system CS (see FIG. 1) may manage the robot to perform the task necessary for the order through the robot battery operation database DB, the robot operating unit 10 and the apparatus 100 for managing the robot battery.

The apparatus 100 for managing the robot battery may manage the battery of the robots assigned to the received task. The apparatus 100 for managing the robot battery may manage the charged state of the battery of the robots to help task distribution of the robot operating unit such that an appropriate robot may be assigned to the corresponding task.

The apparatus 100 for managing the robot battery may collect data related to the operation of the plurality of robots from the robot battery operation database DB and the robot operating unit 10.

The apparatus 100 for managing the robot battery may manage the battery of the robots based on data.

FIG. 4 shows a table of data DD1 and DD2 related to the operation of each of the robot A and the robot C.

The apparatus 100 for managing the robot battery may collect, as the data DD1 and DD2 related to the operation with respect to the robot A and the robot C, the current battery state of charge, the number of remaining tasks and estimated required time, peak task time, and a distance to a usable charger (charging station) from the robot position at the time of completing the task and a battery amount required for the movement.

For example, the apparatus 100 for managing the robot battery may collect the current battery state of charge and the required battery amount from the robot battery operation database DB, and may collect the number of tasks and the estimated required time, the peak task time, and the distance to a usable charger (charging station) from the robot position at the time of completing the task from the robot operating unit 10.

The apparatus 100 for managing the robot battery may periodically update the data DD1 and DD2 related to the operation of the robot. The apparatus 100 for managing the robot battery may periodically check the battery state of charge of the robot. For example, the apparatus 100 for managing the robot battery may update data and check the battery state of charge of the robots at every 10 minutes.

At step S410, the apparatus 100 for managing the robot battery may periodically monitor whether the batteries of currently working robots are sufficient at every 10 minutes. Here, whether the battery is sufficient may be determined based on whether the charged state of the battery of each robot is sufficient for completing the task assigned to that robot.

That is, the apparatus 100 for managing the robot battery may determine whether the current batteries of the robots are sufficient by using data on the number of tasks assigned to the robot, the battery amount necessary for the task and the battery amount necessary for moving to the charging station.

For example, the apparatus 100 for managing the robot battery may determine that the current battery of the robot is sufficient if a value obtained by subtracting the value obtained by adding all of required battery amounts for respective items of remaining task remaining to the robot from the current battery state of charge of the robot is greater than the battery amount necessary for moving from the point of completing the last task of the robot to the charging station by 10% or more.

Supposing that, in the case of the robot A, the state of charge of the battery is 50% and the battery amount required for the one remaining task is 30%, since the remaining battery is 20% and this is greater, by 10% or more, than the battery amount required for moving to the charger, which is 4%, it may be determined that the current battery of the robot A is sufficient.

At step S411, when it is determined that the current battery is not sufficient, the apparatus 100 for managing the robot battery may immediately stop the operation of the corresponding robot and issue the charge command.

At step S412, when the corresponding robot stops the operation and moves to the charging station, the apparatus 100 for managing the robot battery may command the robot to distribute the tasks remaining on the corresponding robot to other robots.

The apparatus 100 for managing the robot battery may issue a command of task distribution to the robot operating unit 10. The robot operating unit 10 may distribute a remaining task to another robot according to the command received from the apparatus 100 for managing the robot battery.

At step S420, when it is determined that the battery of the robot is sufficient, the apparatus 100 for managing the robot battery may determine whether the battery is sufficient until the peak time of the corresponding robot ends.

At step S421, when it is determined that the battery of the robot is not sufficient until the peak time is completed, the apparatus 100 for managing the robot battery may issue a command for stopping the operation after completing the remaining tasks before the peak time and then charging.

The apparatus 100 for managing the robot battery may issue a command for charging after the end of the peak time to the robot until the peak time ends when it is determined that the battery of the robot is sufficient.

For example, when a value obtained by subtracting the first battery amount required for the remaining task assigned to the robot and the second battery amount required for an additional task expected until the task peak time from the current battery state of charge is greater than the third battery amount required for the robot to move to the charging station farthest from the position at the time of completing the task by 10% or more, the apparatus 100 for managing the robot battery may determine that the battery of the corresponding robot is sufficient until the peak time ends.

The robot C will be explained, as an example. In the case of the robot C, the current battery may be 80%. Supposing that a total of the first battery amount with respect to two remaining tasks is 40% and the second battery amount expected until the task peak time is 20%, the remaining battery after the peak time of the robot C is 20%, and this is greater, by 10% or more, than the battery amount required for moving from the position of the robot C at the time of completing the task to the usable charger, which is 2%.

Therefore, the apparatus 100 for managing the robot battery may determine that the current battery of the robot C is sufficient until the end of the peak time. In this case, the apparatus 100 for managing the robot battery may issue a command to the robot C, for moving to the charger after completing all tasks until the task peak time.

In addition, at step S430, the apparatus 100 for managing the robot battery may determine whether charging of the robot C is necessary first before the peak time for a special reason. At step S421, when it is determined that charging is needed first, the apparatus 100 for managing the robot battery may command the robot to terminate the operation after completing the currently remaining task and then move to the charging station.

When it is determined that charging is not needed first, the apparatus 100 for managing the robot battery may command the robot to operate until the end of the peak time.

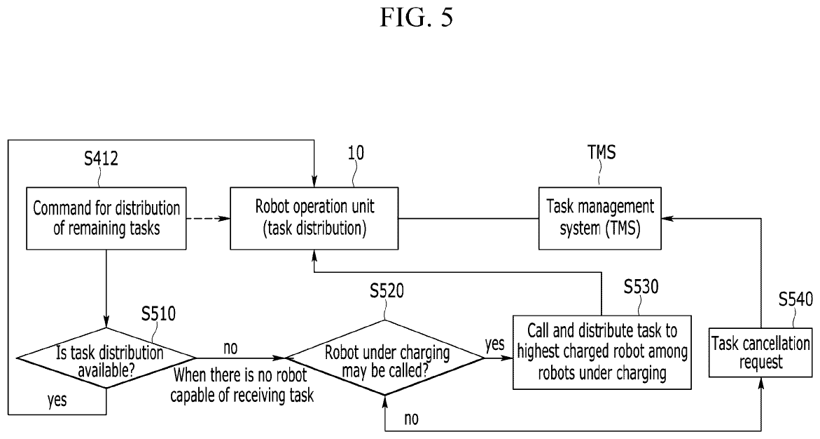

FIG. 5 is a flowchart of a method for managing a robot battery based on operation data. FIG. 5 is a block diagram showing a detailed method of the remaining task distribution command (step S412) of FIG. 4.

The remaining task distribution command of FIG. 5 may be performed by the apparatus 100 for managing the robot battery based on operation data (see FIG. 1). For example, the remaining task distribution command of FIG. 5 may be performed by the task distribution command unit 140 (see FIG. 2).

In FIG. 5, at step S510, the apparatus 100 for managing the robot battery may check whether a robot capable of receiving distribution of remaining tasks exists among currently working robots.

When a currently working robot capable of receiving distribution of tasks exists, the apparatus 100 for managing the robot battery may issue the task distribution command to the robot operating unit 10 to distribute the tasks to them.

For example, the apparatus 100 for managing the robot battery may detect the at least one robot having the third charged state, of which the charged state is determined to be sufficient until the task peak time ends, and may issue the distribution command for distributing the remaining task to the robot having a highest state of charge among the detected at least one robot.

At step S520, when a currently working robot capable of receiving distribution of tasks does not exist, the apparatus 100 for managing the robot battery may check whether a robot that may be called exists among the robots that are currently being charged. The robot that may be called may be a robot that satisfies a preset state of charge.

At step S530, the apparatus 100 for managing the robot battery may issue the distribution command to the robot operating unit 10 such that the robots currently being charged satisfying the preset state of charge so as to be capable of being called are sequentially called from the robot having a greatest state of charge and the remaining tasks are distributed.

At step S540, when a robot that may be called does not exist, the apparatus 100 for managing the robot battery may make a task cancellation request to the task management system TMS.

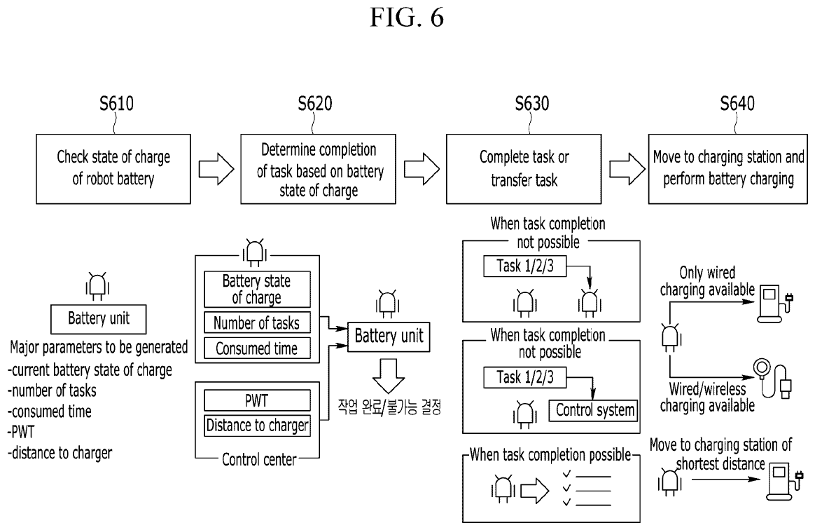

FIG. 6 is a drawing for explaining a method for managing a robot battery based on operation data.

In FIG. 6, at step S610, the apparatus 100 for managing the robot battery based on operation data may check the robot battery state of charge. For example, the apparatus 100 for managing the robot battery based on operation data may check comprehensive information such as the state of charge of the battery mounted on the robot, the assigned number of tasks, a task required time, a current position, and a distance to the charger, with respect to the robot assigned with respect to the customer order request.

The apparatus 100 for managing the robot battery based on operation data may check the information pieces through the battery unit BTT of the robot BOT (see FIG. 1).

The apparatus 100 for managing the robot battery based on operation data may repeatedly check the battery state of charge of the robot at every 10 minutes.

At step S620, the apparatus 100 for managing the robot battery based on operation data may determine whether the robot can complete the corresponding task based on the checked battery state of charge.

The apparatus 100 for managing the robot battery based on operation data may determine possibility of completing the currently processed task based on the preset specific battery amount.

The apparatus 100 for managing the robot battery based on operation data may communicate with the battery unit BTT, and may determine whether the current task can be completed, based on the battery state of charge, the number of tasks, the task required time, or the like.

At step S630, when it is determined that the robot cannot complete the current task, the apparatus 100 for managing the robot battery based on operation data may command transfer of the task to another robot.

When it is determined that completing the task is not possible, the robot may communicate with other nearby robots to transfer the task.

When another robot does not exist nearby the robot, the apparatus 100 for managing the robot battery based on operation data may command the transfer of the task to another robot through the robot operating unit 10 of the robot control system CS.

At step S640, the apparatus 100 for managing the robot battery based on operation data may command the robot having completed the task to terminate the operation and move to the charging station.

The apparatus 100 for managing the robot battery based on operation data may determine capability of wired/wireless charging of the robot and may move the robot to the chargeable charging station in the shortest distance.

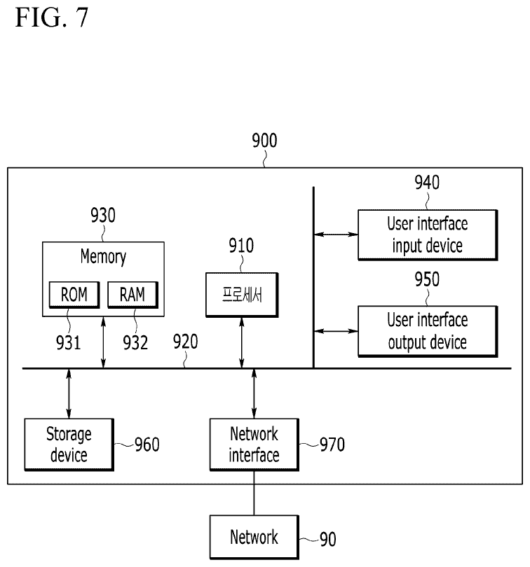

FIG. 7 is a drawing for explaining a computing device.

Referring to FIG. 7, a method and apparatus for managing the robot battery based on operation data can be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 6.

The memory 930 and the storage device 960 may include various types of volatile or non-volatile storage media. For example, the memory may include read-only memory (ROM) 931 and a random-access memory (RAM) 932. In some implementations, the memory 930 may be located inside or outside processor 910, and the memory 930 may be connected to the processor 910 through various known means.

In some implementations, at least some configurations or functions of an apparatus and method for managing a robot battery based on operation data can be implemented as a program or software executable by the computing device 900, and program or software may be stored in a computer-readable medium.

In some implementations, at least some configurations or functions of an apparatus and method for managing a robot battery based on operation data can be implemented by using hardware or circuitry of the computing device 900, or may also be implemented as separate hardware or circuitry that may be electrically connected to the computing device 900.

What is claimed is:

1. An apparatus for managing a battery of a robot, the apparatus comprising:
a robot data collecting unit, implemented using one or more computing devices, configured to periodically collect data related to an operation of the robot;
a charged state monitoring unit, implemented using one or more computing devices, configured to periodically monitor a charged state of the battery of the robot based on the collected data related to the operation of the robot;
a charging management unit, implemented using one or more computing devices, configured to generate, based on the collected data and the charged state, a battery charge command signal to be transmitted to the robot; and
a task distribution command unit, implemented using one or more computing devices, configured to generate, based on the collected data and the charged state, a distribution command signal related to a remaining task to be transmitted to the robot.

2. The apparatus of claim 1, wherein the robot data collecting unit is configured to collect (i) first data related to the battery of the robot from a robot battery operation database and (ii) second data related to a task of the robot from a robot operating unit.

3. The apparatus of claim 2, wherein:
the first data comprises a battery amount to be consumed when the robot moves, a battery amount consumed for the task, and a required battery amount for the task; and
the second data comprises a task amount assigned to the robot, an expected task time, and a task peak time.

4. The apparatus of claim 3, wherein the robot data collecting unit is configured to collect data comprising (i) a distance from a position of the robot at time of completing the task to a charging station and (ii) a required battery amount for the robot to move from the position to the charging station.

5. The apparatus of claim 4, wherein the charged state monitoring unit is configured to, based on the first data and the second data:
determine the charged state as a first charged state based on a determination that the charged state is not sufficient for performing a currently assigned task and immediate charging is necessary;
determine the charged state as a second charged state based on a determination that the charged state is sufficient for completing the currently assigned task but not sufficient until task peak time is completed; and
determine the charged state as a third charged state based on a determination that the charged state is sufficient until the task peak time is completed.

6. The apparatus of claim 5, wherein the charged state monitoring unit is configured to, based on a value obtained by subtracting a first battery amount required for the remaining task assigned to the robot and a second battery amount required for an additional task expected until the task peak time from a current battery state of charge is greater than a third battery amount required for the robot to move to the charging station farthest from the position at the time of completing the task by a predetermined level, determine the charged state as the third charged state.

7. The apparatus of claim 5, wherein the charging management unit is configured to:
based on the charged state of the robot being the first charged state, terminate the operation of robot and generate a first charging command signal for immediately charging the robot;
based on the charged state of the robot being determined as the second charged state, generate a second charging command signal for charging the robot after completing the currently assigned task; and
based on the charged state of the robot being determined as the third charged state, generate a third charge command signal for terminating the operation of the robot and charging the robot after the task peak time is finished.

8. The apparatus of claim 5, wherein the task distribution command unit is configured to detect at least one robot having the third charged state, and generate the distribution command signal for distributing the remaining task that is not processed among tasks assigned to other robots that currently need to be charged, to a first robot having a highest state of charge among the detected at least one robot.

9. The apparatus of claim 8, wherein the task distribution command unit is configured to call a second robot having a highest state of charge among robots that are currently being charged and satisfying a preset state of charge, and, based on the at least one robot having the third charged state not being detected, generate the distribution command signal for distributing the remaining task to the called second robot.

10. The apparatus of claim 1, wherein the charging management unit is configured to, based on an operation-terminated state being announced with respect to the robot having completed the task, generate the charge command signal for moving to and charging at a charging station capable of charging at a shortest distance regardless of the charged state.

11. A method for managing a battery of a robot, comprising:
periodically collecting data related to an operation of the robot;
periodically monitoring a charged state of the battery of the robot based on the collected data related to the operation of the robot;
generating, based on the collected data and the charged state, a battery charge command signal to be transmitted to the robot based on the collected data and the charged state; and
generating, based on the collected data and the charged state, a distribution command signal related to a remaining task to be transmitted to the robot.

12. The method of claim 11, wherein collecting the data comprises:
collecting (i) first data related to the battery of the robot from a robot battery operation database and (ii) second data related to a task of the robot from a robot operating unit.

13. The method of claim 12, wherein:
the first data comprises a battery amount to be consumed when the robot moves, a battery amount consumed for the task, and a required battery amount for the task; and
the second data comprises a task amount assigned to the robot, an expected task time, and a task peak time.

14. The method of claim 13, wherein collecting the data further comprises collecting data comprising (i) a distance from a position of the robot at the time of completing the task to a charging station and (ii) a required battery amount for the robot to move from the position to the charging station.

15. The method of claim 14, wherein monitoring the charged state comprises, based on the first data and the second data:
determining the charged state as a first charged state based on a determination that the charged state is not sufficient for performing a currently assigned task and immediate charging is necessary;
determining the charged state as a second charged state based on a determination that the charged state is sufficient for completing the currently assigned task but not sufficient until task peak time is completed; and
determining the charged state as a third charged state based on a determination that the charged state is sufficient until the task peak time is completed.

16. The method of claim 15, wherein the monitoring the charged state further comprises:
based on a value obtained by subtracting a first battery amount required for the remaining task assigned to the robot and a second battery amount required for an additional task expected until the task peak time from a current battery state of charge is greater than a third battery amount required for the robot to move to the charging station farthest from the position at the time of completing the task by a predetermined level, determining the charged state as the third charged state.

17. The method of claim 15, wherein generating the battery charge command signal to be transmitted to the robot comprises:
based on the charged state of the robot being the first charged state, terminating the operation of the robot and generating a first charging command signal for immediately charging the robot;
based on the charged state of the robot being the second charged state, generating a second charging command signal for charging the robot after completing the currently assigned task; and
based on the charged state of the robot being the third charged state, generating a third charge command signal for terminating the operation of the robot and charging the robot after the task peak time is finished.

18. The method of claim 15, wherein generating the distribution command signal with respect to the remaining task comprises detecting at least one robot having the third charged state, and generating the distribution command signal for distributing the remaining task that is not processed among tasks assigned to other robots that currently need to be charged to a first robot having a highest state of charge among the detected at least one robot.

19. The method of claim 18, wherein generating the distribution command signal with respect to the remaining task further comprises, based on the at least one robot having the third charged state not being detected:
calling a second robot having a highest state of charge among robots that are currently being charged and satisfying a preset state of charge and generating the distribution command signal for distributing the remaining task to the called second robot.

20. The method of claim 11, wherein generating the battery charge command signal to be transmitted to the robot comprises generating, based on an operation-terminated state being announced with respect to the robot having completed the task, the charge command signal for moving to and charging at a charging station capable of charging at shortest distance regardless of the charged state.
